(19) United States
(12) Patent Application Publication
(10) Pub. No.: US 2005/0114154 A1
(43) Pub. Date: May 26, 2005

(54) Personnel monitoring and feedback system and method

(75) Inventors: Richard I. Wolkowicz, Ellenton, FL (US); Joseph Mitchell, Alpharetta, GA (US); Cecelia Mary Berger, Atlanta, GA (US); Martin Shamis, Alpharetta, GA (US); Debra N. Welchel, Woodstock, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/720,776

(22) Filed: Nov. 24, 2003

(51) Int. Cl. G06F 17/60

(52) U.S. Cl. 705/1; 705/14

(57) ABSTRACT

A method and system of providing feedback to personnel performing a given procedure is provided. The system and methodology comprises at least one sensor carried by each piece of required equipment. The sensor is configured to contain information to identify the piece of equipment in which it is configured. In addition, at least one sensor is carried by an individual or positioned in an individual's environment. The sensor is configured to detect a hazardous change. Further, at least one other sensor is configured to detect at least one characteristic of an individual's physiological condition. The sensor is positioned adjacent an individual during a procedure. The individual desirably carries a scanner to permit communication with sensors. The scanner is configured to send and receive signals from the sensors. The scanner is also configured to communicate information from the sensors to an individual when a change is detected, and to communicate countermeasures available to an individual to counteract any change.

### BACKGROUND

The present invention relates generally to the field of personnel monitoring and feedback, and more particularly to a system and method for monitoring personnel performing procedures requiring protective garments, equipment, and so forth while working in potentially hazardous conditions.

Radio Frequency Identification Devices (RFIDs) are low-cost, passive “smart” chips or “tags” that can be embedded in or attached to articles, products, and the like, to convey information about the product via a scanner. The smart tags are generally small labels or the like with a miniature embedded antennae. The tags may be passive or active. Active tags require an internal power supply. A reader or scanner interrogates the smart tag with an electronic “trigger” signal. The tag in turn generates an electromagnetic pulse response that is readable by the scanner, the response containing the product information. RFID smart tags can be embedded in or attached to product packaging, or incorporated directly into the product, and may convey conventional “bar code” information, as well as other more detailed information.

Various commercial applications have been suggested for smart tags, particularly in the area of retail marketing and sales. For example, RFID technology may be used to gather information related to consumer trends, purchasing habits, consumption rates, etc. It has also been suggested that RFID technology has promise in the areas of inventory control, manufacturing process and control, product accountability and tracking systems, etc. Manufacturers, shippers, and retailers may be able to follow a given product through their respective systems from initial production through to point of sale. It has been suggested that other applications may include shopping carts that automatically charge a bank account, refrigerators that tap into the Internet to automatically reorder items that are running low, and interactive televisions linked to such refrigerators that will feed targeted commercials and special offers to consumers. (See, “They Know What You Eat,” by Kayte VanScoy, Smart Business, January 2001).

The present invention relates to a novel implementation of RFID and other technology. Such technology permits personnel to be correctly attired when performing specific procedures. It also permits an individual to monitor for potential hazards. Further, it permits the individual to be monitored for physiological changes while working in the potentially hazardous area/environment. Finally, the technology permits feedback to the individual of all proper garments/equipment and their performance for that particular individual, as well as feedback regarding hazards in the area/environment and negative physiological changes to the individual. Such feedback includes countermeasures which may be used to protect the individual while working in the area/environment.

There are any number of conceivable work environments wherein personnel are required to wear protective clothing or articles. For example, personnel involved in the nuclear industry must wear radiation protective clothing, personal dosimetry devices, and so forth. Law enforcement personnel are required to wear protective vests, helmets, etc., in any number of situations. Firefights wear protective garments, boots, helmets, gloves, and so forth, and carry numerous pieces of fire-fighting equipment.

Presently, there is no system for ensuring that personnel wear the required articles and carry the required equipment, and so forth. Further, no system exists which customizes the garments and equipment to meet individual needs as well as situational procedures. And no feed back system, such as a scanner, is presently provided to an individual, to provide feedback on garments, equipment, and so forth, and to provide additional information to an individual in a changing situation, such as, for example, information on regarding dynamic and changing chemical issues to firefighters fighting a chemical plant fire.

Moreover, no system exists which provides sensors, such as biosensors which may be positioned on the garments, equipments and/or the environment, and so forth, to assess the requirements or hazards for a specific situation and/or procedure. Nor is there a feedback system which provides information from such sensors to the individual. Such a feedback system desirably receives information from the biosensors, analyzes it, and provides the information to the individual regarding the nature of a hazard encountered. And such a feedback system communicates with the individual and provides one or more recommendations regarding protective countermeasures available to counteract any hazard(s) encountered. For example, in monitoring firefighters fighting a fire, such a system desirably monitors for dangerous gases, such as carbon monoxide, and so forth, and informs the individual of the immediate need to use oxygen being carried by the individual.

Finally, no feedback system exists which provides sensors, such as medical sensors which may be positioned on garments, equipment, or an individual's body, to assess health risks of the individual while performing a specific procedure and/or working in a certain environment. Such a feedback system desirably provides information to the individual regarding the individual's health, and warns the individual when negative physiological changes occur. Such a system also desirably communicates with the individual and makes a recommendation regarding protective countermeasures available to counteract any negative physiological changes which the individual is experiencing, so that an individual is informed of what medication to immediately administer, or where a nearby medical aid station is located relative to the individual's position within in a specific area/environment.

The present invention provides systems and methodology which address these needs. Use of RFID “smart” tags along with biosensors, medical sensors, scanners, information centers, and so forth, permits monitoring and feedback to an individual performing a specific procedure in a potentially hazardous area/environment. The type of procedure or work environment is not intended as a limiting factor to the invention, as will be set forth in greater detail below.

### SUMMARY

Objects and advantages of the invention will be set forth in the following description, or may be obvious from the description, or may be learned through practice of the invention.

The present invention includes a method of providing feedback to personnel performing a given procedure. The equipment that an individual is required to have for performing a procedure is identified by configuring a sensor with the equipment. The sensor contains information to identify each respective piece of equipment in the system in which it is configured. At least one sensor is provided which is carried by an individual. The sensor is configured to detect a hazardous change. At least one sensor is provided which is configured to detect at least one characteristic of an individual's physiological condition. The sensor is desirably positioned adjacent the individual during a procedure. A scanner is provided to an individual to permit communication with sensors. The scanner is configured to send and receive signals from the sensors. The sensors are scanned by the scanner, which communicates information from the sensors to an individual when a change in any sensor is detected. The scanner also communicates countermeasures available to an individual to counteract a change.

In another aspect of the invention, a system of providing feedback to personnel performing a given procedure is provided. The system comprises at least one sensor carried by each piece of required equipment. The sensor is configured to contain information to identify the piece of equipment in the system in which it is configured. In addition, at least one sensor is carried by an individual; the sensor is configured to detect a hazardous change. Further, at least one sensor is configured to detect at least one characteristic of an individual's physiological condition. The sensor is positioned adjacent an individual during a procedure. The individual desirably carries a scanner to permit communication with the sensors. The scanner is configured to send and receive signals from the sensors. The scanner is also configured to communicate information from the sensors to an individual when a change is detected, and to communicate countermeasures available to an individual to counteract any change.

Additional aspects of the present methodology and system will be described below with reference to the figures.

### Definitions

Sensors as used herein refers to a smart (RFID) tag, a biosensor, a medical telesensor, or other medical sensor, such as, by way of non-limiting example, an electrode positioned on or adjacent an individual which is used to transmit medical data, such as, by way of non-limiting example, heart rate, respiration rate, blood oxygen levels, and so forth, to a scanner and/or information center, such as a computer system or network. A medical sensor may include a transmitter having an antennae as well.

Scanner as used herein refers to a smart tag scanner, a biosensor scanner, a scanner for medical telesensors, other medical scanners, and the like. Desirably, one scanner may be used for all sensors (smart tags, biosensors, medical sensors), or, alternatively, scanners may be specific for a particular use, for example, a biosensor scanner may be used only to scan biosensors. One or more scanners may transmit data to each other, to a receiver such as a PDA, to any information center, such as a computer system, and/or to other information receiving/relaying source(s) known in the art.

The terms “equipment”, “garment”, and so forth, is meant to encompass any device, apparatus, piece of equipment and/or piece of apparel that is required to be worn or donned by an individual prior to performing a particular procedure, during a particular procedure, and immediately after a particular procedure.

The terms “physiological information”, “physical condition”, “medical condition”, “physiological characteristic” as so forth is meant to encompass any physiological parameter of an individual, such as, but not by way of limitation, heart rate, respiration, temperature, blood oxygenation levels, blood pressure, and so forth.

The terms “counter measures” and/or “preventative measures” includes any equipment or item carried by an individual to counteract a change. For example, extra gloves would counteract the need to replace one or more gloves which were lost or damaged during a procedure; a nerve gas antidote carried by the individual may be quickly self administered to counteract nerve gas detected in the environment. In addition, the terms include, but are not limited to, information regarding nearby locations where, by way of non-limiting example, medical aid, medication, decontamination chambers, extra oxygen tanks, and so forth may be obtained by the individual.

The term “change” includes, but is not limited to, any change in an area and/or environment detected by any sensor, such as a hazardous change due to a spill of hazardous waste, a loss of equipment or failure of equipment detected by a sensor, a lack of all necessary equipment detected by a scan of sensors, any alteration of a physiological characteristic of an individual being scanned, for example, a rapid heart rate (over 100 beats a minute), an elevated temperature (over 99 degrees F.), and so forth, of an individual.

These terms may be defined with additional language in the remaining portions of the specification.

### BRIEF DESCRIPTION OF THE DRAWINGS

FIG. 1 is a graphic illustration of concepts according to a method and system of the invention, showing items having RFID tags communicating with a scanner after prompting from the scanner;

FIG. 2 is another graphic illustration of concepts according to a method and system of the invention, illustrating an individual using a scanner to identify the proper equipment designated to perform a specific procedure;

FIG. 3 is yet another graphic illustration of concepts according to a method and system of the invention, illustrating a scanner receiving information from both a computer network and items used to perform a specific procedure; and

FIG. 4 is still another graphic illustration of concepts according to a method and system of the invention, illustrating an individual wearing and using specific equipment having RFID tags and medical sensors or telesensors in an environment, wherein biosensors have been disposed in the environment and on equipment and/or garments, and the individual is using one or more scanners in communication with a computer database (not shown) to evaluate the environment as well as the individual's well-being.

### DETAILED DESCRIPTION

Reference will now be made in detail to one or more embodiments of the invention, examples of which are graphically illustrated in the drawings. Each example and embodiment are provided by way of explanation of the invention, and not meant as a limitation of the invention. For example, features illustrated or described as part of one embodiment may be utilized with another embodiment to yield still a further embodiment. It is intended that the present invention include these and other modifications and variations.

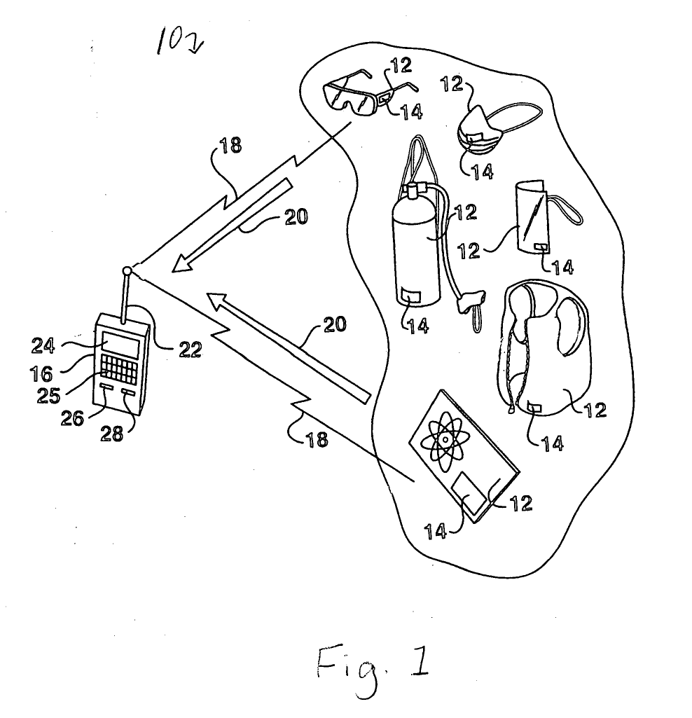

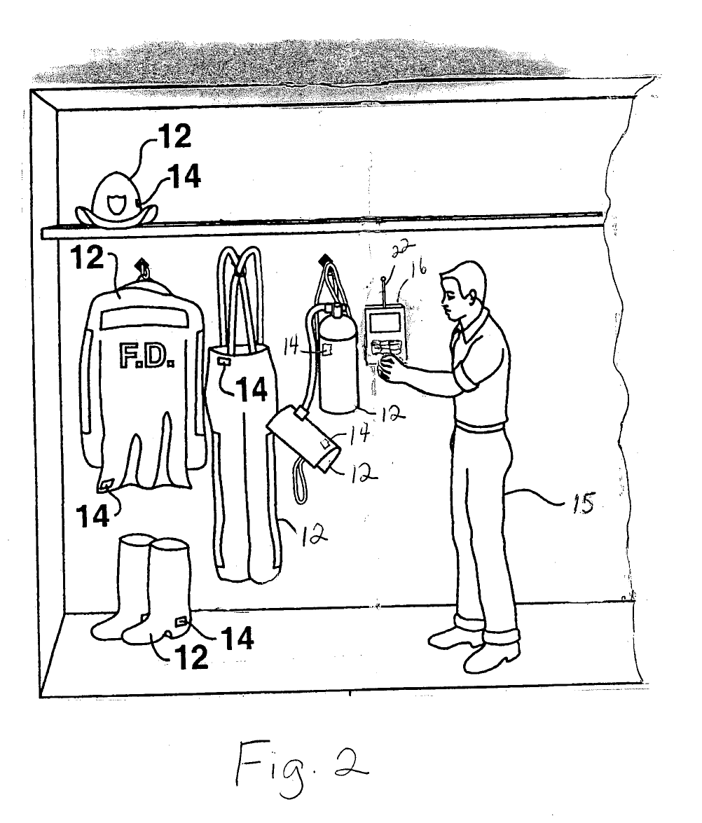

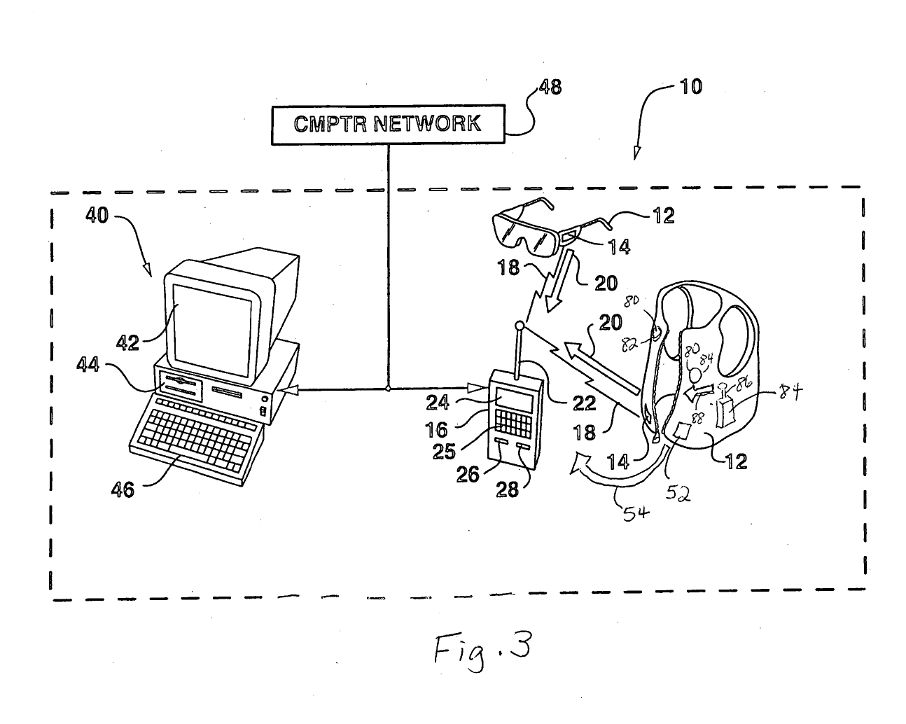

FIGS. 1-3 graphically illustrates one aspect of a method and system 10 according to the invention. Any type or variation of equipment and/or garment 12 (equipment and garments identified collectively by the numeral 12) that is required to be worn or donned by an individual 15 (FIG. 2) prior to performing a particular task or work function, while performing the particular task, or immediately after performing a particular work function, is provided with an RFID tag or smart tag 14. It should be appreciated that the invention is not limited to any particular category or type of equipment and/or garment 12, but generally encompasses all types of safety gear, protective clothing, assisted breathing devices, and virtually any device or article that is placed on or about an individual's body for ensuring the safety of the individual or equipment. For example, in FIG. 1 safety glasses, a face mask, a protective vest, a gas tank/mask breathing apparatus, a face shield, and a radiation dosimetry device are all illustrated as exemplary embodiments of necessary garments and/or equipment 12 for performing particular functions. The type of task or function to be performed by the individual 15 (FIG. 2) will dictate the particular equipment and/or garments 12 required. FIG. 1 is meant to conceptually convey this idea, and is not a limitation of the invention. As discussed in greater detail below, the smart tags 14 transmit a pulse of coded equipment information 20 (FIGS. 1 and 3) in response to an electronic “trigger” signal 18 from a scanner 16. The scanner includes an antennae 22 for transmitting the trigger signal 18 and receiving the pulsed equipment information signal 20. The smart tags 14 may be attached, adhered, incorporated in, or otherwise associated with the respective pieces of equipment and/or garments 12 by any suitable means, including adhesives, mechanical fasteners, and the like. In particular embodiments, the smart tags 14 may be incorporated as integral components of the equipment. Alternatively, the smart tags 14 may be provided as separate components, such as adhesive labels or tags, which are attached to the pieces of equipment.

A scanner 16 is provided to each individual 15, and is desirably attached to or associated with the garment or piece of equipment 12, and so forth, worn by the individual. The scanner 16 may be configured to receive information from an information center, which will be described in further detail below, or it may have programming, software, and so forth, provided therein or associated via another device, such as a PDA, and so forth. The scanner 16 is configured to receive information from the smart tags 14, such an data sent by smart tags to identify a piece of equipment being utilized. All capabilities of smart tags 14 and scanners 16 will be described in further detail below.

Either before or after donning the appropriate equipment for a given procedure, as illustrated in FIG. 2 (prior to donning garments and/or equipment 12), the individual 15 desirably activates the scanner 16 and scans himself/herself to determine whether all appropriate garments and/or equipment 12 are being utilized by the individual 15. The scanner 16 may have information programmed therein, or the scanner may communicate with a separate database (wireless communication) regarding garments and/or equipment 12, and so forth, needed for the specific procedure, as well as any special needs of the specific individual 15 who using the garments and/or equipment 12 required for the procedure.

Another embodiment of the system 10 may include individual smart tags 14 assigned or otherwise associated with each individual 15. These personal smart tags 14 contain information identifying each individual 15. Therefore, when an individual 15 is scanned by the scanner 16, the individual's smart tag 14 is activated and that particular individual 15 is identified. The individual's identity may then be used for verifying that any individual-specific requirements as to equipment and/or garments 12, and so forth, is satisfied. For example, the scanner 16 may include or be in communication with a computer having an electronically stored profile for each individual 15. This profile may include the necessary equipment pieces and garments 12 that are required by that respective individual 15. Upon identification, the individual's profile is called up and an equipment accountability check is conducted against the profile. The system 10 may include an electronic library or database containing a plurality of individual specific profiles. This system 10 may also be particularly useful wherein a number of individuals perform different tasks requiring different pieces of equipment.

As the individual 15 scans his/herself, his/her garments and/or equipment 12 using the scanner 16, the smart tags 14 thereon, therein, or associated therewith come within range of the scanner 16. With conventional RFID “smart” systems, the smart tags 14 are passive devices and the scanner 16 emits the trigger excitation signal 18 which is received by an internal antennae in the smart tags 14. This signal 18 causes the smart tags 14 to generate and transmit an electromagnetic pulse containing the coded equipment identifying information signal 20. The coded signal 20 is received by the receiver antennae 22 and decoded. The scanner checks the scanned equipment pieces 12 against a list of required garments and/or equipment 12, and communicates the completeness or incompleteness of the required equipment 12 to the individual 15. Such communication may be visual, auditory, and so forth, as will be described in further detail below.

In the event that the individual 15 does not have all of the required garments and/or equipment 12, the scanner 16 may also include or activate any type of audible alarm 28, visual alarm 26, or tactile alarm (for example, vibration of the scanner 16 or other mechanism), and so forth. Alternatively, the scanner 16 may be in communication with a remotely disposed alarm (not shown).

An audible alarm 28 may be transmitted by one or more speakers in the scanner 16 and/or associated apparatus (such as a PDA) to allow the individual and others to hear the alarm, or the audible alarm 28 may be directed exclusively to the individual, and may include a voice alarm. For example, narrow beams of sound may be projected to the individual using hypersonics sound technology, such as that provided by American Technology (San Diego, Calif.). Principles of hypersonic sound systems are described in a white paper entitled, “Theory, History, and the Advancement of Parametric Loudspeakers: A Technology Overview,” by James J. Croft and Joseph 0. Norris, Revision D, American Technology Corporation, San Diego, Calif., 2002, available at http://www.atcsd.com/pdf/HSSWHTPAPERRevD.pdf. Exemplary applications of hypersonic technology are illustrated at http://www.popsci.com/popsci/hometech/article/0,12543,351353,00. html.

RFID smart tag technology is known and understood by those skilled in the art, and a detailed explanation thereof is not necessary for purposes of describing the method and system according to the present invention. Generally, conductive or passive smart tags 14 consist of silicon, a coiled, etched, or stamped antennae, a capacitor, and a substrate on which the components are mounted or embedded. A protective covering is typically used to encapsulate and seal the substrate. Inductive or passive smart tags have been introduced by Motorola under the name “BiStatix”. A detailed description of the BiStatix device may be found in U.S. Pat. No. 6,259,367 B1, incorporated herein by reference in its entirety for all purposes. Another commercial source of suitable smart tags is Alien Technology Corporation of Morgan Hill, Calif., under the technology name FSA (Fluidic Self-Assembly). With the FSA process, tiny semi-conductor devices are assembled into rolls of flexible plastic. The resulting “smart” substrate can be attached or embedded in a variety of surfaces. The smart tag technology under development at the Auto-ID Center at Massachusetts Institute of Technology (Cambridge, Mass.) can also be used within the scope of the present invention. Further information on smart tags and related technology is disclosed in U.S. Pat. No. 6,451,154, “RFID Manufacturing Concepts,” issued Sep. 17, 2002 to Grabau et al.; U.S. Pat. No. 6,354,493, “System and Method for Finding a Specific RFID Tagged Article Located in a Plurality of RFID Tagged Articles,” issued Mar. 12, 2002 to Mon; PCT publication WO 02/48955, published Jun. 20, 2002; U.S. Pat. No. 6,362,738, “Reader for Use in a Radio Frequency Identification System and Method,” issued Mar. 26, 2002 to Vega; D. McFarlane, “Auto-ID Based Control,” White Paper for the Auto-ID Centre Institute for Manufacturing, University of Cambridge, Cambridge, United Kingdom, Feb. 1, 2002, available at http://www.autoidcenter.org/research/CAM-AUTOID-WH-004.pdf; and Chien Yaw Wong, “Integration of Auto-ID Tagging System with Holonic Manufacturing Systems,” White Paper for the Auto-ID Centre Institute for Manufacturing, University of Cambridge, Cambridge, United Kingdom, September 2001, available at www.autoidcenter.org/research/CAM-WH-001.pdf.

Other RFID technologies believed to be of value for the present invention include those produced by Microchip Technologies (Chandler, Ariz.), which provides remote read-write chips at several frequencies. Also of potential value are the I*CODE chips and readers of Philips Semiconductor (Eindhoven, The Netherlands), which, in one embodiment, are said to include 384 bit configurable read/write memory with 64 bits for a unique serial number (e.g., an electronic product code). Sokymat (Lausanne, Switzerland) markets the PICCOLO read-only RFID disc tag which transmits data to a reader station by an AM radio signal. The tag is said to have 64 bits of data that can be programmed during manufacturer by laser fusing of polysilicon links in order to store a unique code on each tag.

Texas Instruments (Dallas, Tex.) offers RFID technology as part of Texas Instruments RFID (TI*RFID™) Systems, formerly known as the TIRIS© system (Texas Instruments Registration and Identification System), which is used to track and identify various assets using devices such as the TI Tag It™ chip.

Gemplus (Gemenos, France) provides smart tags (sometimes called “smart labels”) and smart cards employing RFID technology, which may be used as smart tags. They also market interfaces, antennas, scanners and software that can be adapted for use with smart tags.

Nedap (Groenlo, The Netherlands) provides smart cards and a13.56 MHz smart tag using RFID technology with 512 bits of read-write memory with a range of about 120 cm. It is claimed that about 20 such tags per second can be read successfully by a scanner.

Checkpoint Systems Inc. (Miami, Fla.) offers a smart tag with WORM technology (write once, read many). One example is the MCRF355 chip, described more fully at http://www.idsystems.com/reader/1999_{—}05/join0599.htm.

PDA-like reader systems and other portable readers for RFID technology are marketed by Omron Company (Tokyo, Japan), such as the Model V700 or V720 series.

High frequency bands can be used in RFID technology, such as bands between 300 MHz and 10 GHz. SCS Corporation (Rancho Bernardo, Calif.), for example, markets smart tag technology at 2.45 GHz. Ultra-wide band technology can also be adapted for RFID systems.

A related technology within the scope of the present invention is Surface Acoustic Wave (SAW) technology. For example, InfoRay (Cambridge, Mass.) markets a passive smart tag that is said to achieve long ranges (up to 30 meters) using a Surface Acoustic Wave (SAW) device. On a chip coupled with an antenna. The SAW device converts a radio signal to an acoustic wave, modulates it with an ID code, then transforms it to another radio signal that is emitted by the smart tag and read by a scanner. The ID code of the smart tag is extracted from the radio signal. The scanner is said to compare the spectral content of the signal with a database of signatures and to derive the ID code. This method enables a read range of up to 30 m (typical 10-20 m). The system can operate in the 915 MHz band and 2.45 GHz band. RFSAW, Inc. (Dallas, Tex.) also provides minute Surface Acoustic Wave (SAW) RFID devices that can be used within the scope of the present invention.

The antennae embedded within the smart tags 14 is typically a useful component of the device, though it is recognized that alternatives to antennas may exist in some applications. (For example, for some metallic objects, the smart tag need not comprise an antenna but the metallic object itself can serve as the antenna.) The excitation signal 18 from the scanner 16 is received by the antennae to “activate” the smart tag 14. The received excitation signal 18 is the power source for the smart tag 14 and results in the generation of the electromagnetic pulse containing the coded food product information signal 20. A detailed description of RFID smart tag antennas may be found in U.S. Pat. No. 6,320,556 B1, incorporated herein by reference for all purposes.

In an alternate embodiment, the smart tags 14 may be active devices. In this configuration, the smart tag 14 includes active transceiving circuitry that has the capability to selectively respond to coded request signals transmitted by a scanner 16. The active smart tag 14 may include the capability to receive and store additional information beyond the information contained in its fixed code. An active smart tag 14 requires an internal power supply, such as a micro-battery, thin film battery, or the like.

The scanner 16 may be of conventional hardware and software architecture. The scanner 16 receives the coded equipment information signal 20, and the decodes the signal into usable commands and data. The scanner 16 includes a microprocessor and software programs for this purpose. The scanner 16 provides an output to the individual 15 that may be in various forms. For example, the scanner 16 may visually display the identified pieces of equipment 12 by way of a visual display screen 24. Alternatively, as described previously, the scanner 16 may include any configuration of visible alarm 28, audible alarm 26, and/or tactile alarm.

Each smart tag 14, or any sensor shown and/or described herein, may include a link or code to a remote database having additional equipment information. This link or code may enable the scanner 16 to communicate with such database by conventional wireless or wired technology. For example, referring to FIG. 3, the scanner 16 may be in communication with an information center or computer system 40 which may have a monitor 42, a CPU 44, and a keyboard 46. The computer system 40 may have access to an internal or external computer network 48. The computer system 40 may also be Internet accessible. The signal 20 may include an URL code to launch an Internet browser application. In this way, the scanner 16 or computer 40 may provide the individual 15 or other remote individuals with Internet access to websites containing additional information. The scanner 16 may be an Internet accessible wireless device, such as a PDA (Personal Data Assistant) device. The scanner 16 may include a visual display screen 24 and a keypad 25 for interactive communication with the remote database or Internet.

The garments and/or equipment 12 worn by each individual may also include one or more biosensors 52. Such biosensors 52 are provided to in one or more locations on at least one garment and/or piece of equipment 12, to permit monitoring of temperature, hazardous materials (liquids, solids, gases), including, but not limited to, chemicals, toxins, biological hazardous materials and/or organisms, such as, for example, anthrax, nuclear materials/hazards, acidity levels (pH), and so forth. Biosensors 52 detect, record and/or transmit information regarding a physiological change or the presence of various chemical or biological materials in the environment.

Biosensors 52 are preferably combined with an electronic component to yield a measurable signal. That is, a biological component, such as, for example, a whole bacterium, an enzyme, or an antibody, is combined with an electronic component, such as, by way of non-limiting example, a smart tag, to yield a measurable signal. Such a measurable signal may be produced, in another embodiment, by a biosensor which may include a biological or chemical sensing element, a transducer, a signal conditioner, a data processor, and a signal generator.

Biosensors 52 may come in a large variety of shapes and sizes, and may be combined with active or passive smart tags, and any equivalent. Transmission may occur from the biosensors 52 when the scanner 16 emits a trigger exhitation signal 18 which is received by an internal antennae in the biosensor 52. The signal 18 causes the biosensor 52 to generate and transmit an electromagnetic pulse 54 containing data from the biosensor 52. Alternatively, the biosensor may be active, such as previously described herein for “active” smart tags. In either instance, the information from the biosensors 52 is transmitted to the scanner 16, or, alternatively, to a biosensor scanner configured specifically to receive the biosensory information (not shown). While either scanner may be used, it will be understood that the term “scanner” as used in conjunction with biosensors 52 encompasses either or both scanners. In another embodiment, the scanner 16 may be connected (through a wired or wireless connection) to any PDA-like device described herein. In yet another embodiment, the scanner 16 may transmit information received from biosensors 52 to the information center or computer system 40. Alternatively, the scanner 16 may include programs and/or software to interpret the signals 54 from the biosensors 52, and communicate with the individual 15.

Any type of biosensor, for example, but not by way of limitation, an optical biosensor, a non-optical biosensor, such as microcantilevers, and so forth, may be used, along with any transmission apparatus described herein or known in the art, to produce a measurable signal. Examples of biosensors include FRESH ALERT™ biosensors manufactured by Infatab, 4347 Raytheon Road, Oxnard, Calif. and SAFE CHECK™, available from Global Technology Resources, Manchester, England, United Kingdom. Information regarding biosensors and other medical and environmental probes are found at www.ornl.qov/ORNLReview/rev29 3/text/buisens.htm.

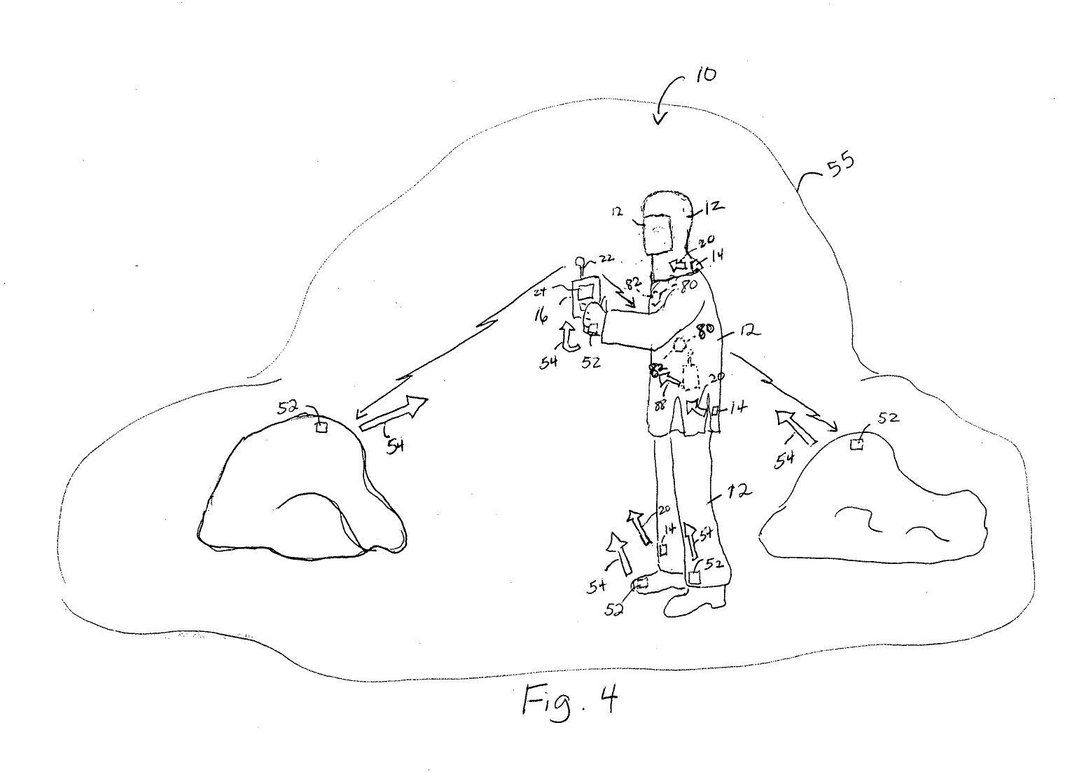

Biosensors 52 may be applied to, attached to, or incorporated, partially or completely, in any equipment and/or garment 12 that is selected for a particular procedure, and worn by the individual 15 performing at least a portion of the procedure. Biosensors 52 may be positioned on garments 12, such as, for example, gloves, hoods, boots, and so forth. Alternatively, as shown in FIG. 4, one or more biosensors 52 may be placed in the environment 55 and monitored by the individual 15. Such placement may be by air dispersal, by liquid dispersal, by physical placement by the individual 15, and so forth.

Desirably, after donning the appropriate garments and/or equipment 12, as determined by an initial scan of smart tags 14, the individual 15 may activate the system 10 which periodically scans the biosensors 52 on the garments and/or equipment 12, or placed in the environment 55. For example, the scanner 16 may activate any sensors, (smart tags 14 and/or biosensors 52), every two (2) minutes to transmit data to the scanner 16. Alternatively, active smart tags 14 and/or active biosensors 52 may be set to transmit to a scanner 16 or a nearby information center automatically and periodically. In yet another alternative, such active smart tags 14 and/or active biosensors 52 may transmit only when a change occurs to produce a measurable signal, such as when a required piece of equipment 12 is damaged while working and the smart tag 14 therefore fails to transmit a signal, or when a biosensor 52 senses a change in the environment 55. In such a system 10, if one or more biosensors 52 provided a signal indicating the presence of a hazard, the scanner 16 desirably receives the information and communicates the information to the individual 15, in any manner described herein. Desirably, the information from the sensors may also be transmitted to the information center or computer system 40, either directly, by the sensors (smart tags 14 or biosensors 52), when the computer system 40 is located nearby, or via the scanner 16.

As a part of the system 10, preventative measures and/or counter measures may be provided and communicated to the individual 15 by the scanner 16, either from information pre-programmed therein, or information transmitted from the information center or computer system 40. Such counter measures may include, for example, a prompt to use of additional garments and/or equipment 12 being carried by the individual 15, such as putting on a gas mask, activating a new oxygen tank, and so forth. Counter measures may also include providing information to the individual 15 of a nearby location where additional equipment or aid, such as, by way of non-limiting example, additional oxygen tanks, antibiotics, nerve gas antidote, and so forth, may be obtained.

In addition, each individual 15 may have one or more medical sensors 80, such as, but not by way of limitation, electrodes 82 positioned against or near the individual's skin and which communicate with a transmitter 84 desirably having an antennae 86 for wireless transmission to the scanner 16 or medical scanner (not shown). Alternatively, the medical sensors 80 are capable of transmission, either actively or passively, in a manner described herein previously for other sensors. That is, the medical sensors 80 may be positioned against or attached directly to the individual's skin, or the medical sensors 80 may be placed adjacent to the individual via garments 12, as shown in FIG. 4 and/or other apparatus in a configuration which permits the medical sensors 80 to gather physiological information from the individual, such as, for example, blood pressure, heart rate, respiration, temperature, blood oxygenation levels, and so forth.

Such medical sensors 80 may be standard medical sensors 80 (for example, electrodes) attached to standard medical transmitters 84, such as, for example, those used in cardiac units and epilepsy units, and so forth, which are known in the art. Alternatively, medical telesensors utilizing smart tags technology (active or passive) may be used. Desirably, any form of medical sensor which permits wireless transmission to the scanner 16, a medical scanner, or other information receiving device, such as a PDA, an information center or computer system 40, and so forth, may be used.

As part of the system 10, transmission from the medical sensors 80 may occur when medical sensors 80 or the medical transmitter 84 is prompted by the scanner 16 via a trigger excitation signal, which is received by an antennae (not shown) of the medical sensor 80, or by the antennae 86 of the transmitter 84. The transmitter 84 may contain programs and/or software such that it takes a “reading” of a medical signal, such as a patient's heart rate, for a short period of time, and then transmits the information via an electromagnetic pulse 88, and so forth, to the scanner 16 upon receiving trigger excitation signal 18 from the scanner 16. In another alternative, the transmitter 84 may be set, or receive information from the scanner 16, to transmit the medical information periodically, such as, for example, every two (2) minutes, as previously described herein.

One example of medical sensors and combined with a receiver (scanner) is A-LIFE™, which provides garments and medical sensors which transmit an individual's physiological information, such as heart rate, respiration, and blood oxygenation levels (from an oximeter worn around a toe) to a remote scanner. A-LIFE ™ is provided by the Swiss Federal Institute of Technology, (Ecole Polytechnique Federale De Lausanne), Ecublens, CH-1015, Lausanne.

In another example, sensors, such as medical sensors 80, and/or medical telesensors (not shown), combine the ability to obtain medical information and transmit the information to a wireless scanner, a PDA, an information center or computer system 40, and so forth as well. Medical sensors 80, such as electrodes, are well known in the art and commercially available. Medical telesensors developed by Oak Ridge National Laboratory, Oak Ridge, Tenn., may also be used.

Desirably, after donning the appropriate garments and/or equipment 12, as determined by a scan of the smart tags 14, the individual 15 may desirably activate the system 10 which periodically scans the medical sensors 80 and/or all of the sensors 14, 52, 80. For example, a scanner 16 may activate any medical sensor 80 and/or transmitter 84 every two (2) minutes to transmit data to the scanner 16 or computer system 40. The scan may be set to continue for ten (10) to fifteen (15) seconds, for example, to obtain sufficient information from the medical sensors 80. Alternatively, however, the medical sensors 80 or the medical transmitters 84 may have memory included therein and may have a recent transmission in memory which is transmitted to the scanner 16 or the information center/computer center 40. In another alternative, the information center/computer system 40 determines the scan or scanning intervals, and transmits this information to the scanner 16, medical transmitter 84 and/or the medical sensors 80. In such a system 10, if one or more medical sensors 80 provides a signal indicating the presence of a negative physiological change, the scanner 16 and/or medical transmitter 84 would transmit or communicate this information to the individual 15. Such notification may be visual, auditory, and/or tactile, as previously described herein. Desirably, the information from the medical sensors 80 would also be transmitted to the information center/computer center 40.

As part of the system, preventative measures or counter measures may be provided and communicated by the scanner 16 and/or the medical transmitter, either from information pre-programmed therein, or information transmitted from the information center/computer system 40, based upon the transmission of negative physiological change. Such counter measures may include, for example, prompt administration of oxygen, the administration of a medication or pharmaceutical agent carried by the individual, and so forth. Such counter measures may also include providing information to the individual of a nearby location where additional equipment or aid, such as, by way of non-limiting example, a de-contamination center, an aid center having medical personnel and medication, and so forth, may be located.

Desirably, the sensors (smart tags 14, biosensors 52, medical sensors 80) of the system 10 work together to protect the individual 15, and to assure that the individual is protected before, during and after performance of the specific procedure in an area or environment 55. Smart tags 14 monitor equipment presence and status, while biosensors 52 and medicals sensors 80 provide periodic information regarding the environment 55 and the individual's physiological condition. The individual 15 is desirably notified immediately if change occurs. Upon detection of any change, the system 10 acts not only to notify but to provide countermeasures, i.e., information regarding additional equipment, medications, location of aid, and so forth, but continues to provide on-going information to the individual 15, should additional changes by detected.

It should be appreciated by those skilled in the art that the system and method according to the invention have wide applications, and that the examples and embodiments set forth herein are merely exemplary. It is intended that the present invention include such uses and embodiments as come within the scope and spirit of the appended claims.

1. A method of providing feedback to personnel performing a given procedure, the method comprising:
identifying equipment that an individual is required to have for performing a procedure by configuring a sensor with the equipment, the sensor containing information to identify each respective piece of equipment it is configured with,
providing at least one sensor carried by an individual, the sensor configured to detect a hazardous change;
providing at least one sensor configured to detect at least one characteristic of an individual's physiological condition, the sensor positioned adjacent the individual during a procedure;
providing a scanner to an individual to permit communication with sensors, the scanner configured to send and receive signals from the sensors,
scanning the sensors and communicating information from the sensors to an individual when a change in any sensor is detected; and
communicating countermeasures available to an individual to counteract the change.

2. The method of claim 1, wherein the equipment includes a garment.

3. The method of claim 1, wherein the sensor on the equipment includes a smart tag.

4. The method of claim 1, wherein the sensor carried by an individual includes a biosensor.

5. The method of claim 1, wherein one sensor configured to detect at least one characteristic of an individual's physiological condition includes a medical sensor.

6. The method of claim 5, wherein the medical sensor includes a transmitter associated therewith.

7. The method of claim 1, wherein a change includes a change in an environment, a failure in equipment, a loss of equipment detected by a sensor, a lack of all equipment required for a procedure detected by a scan, any negative alteration of a physiological characteristic of an individual being scanned, and any combination thereof.

8. The method of claim 1, wherein countermeaures includes any item carried by an individual which at least partially counteracts a change and any information provided to an individual about a nearby location to obtain an item to at least partially counteract a change.

9. The method of claim 1, comprising displaying the identification of the pieces of equipment identified by the scanner to the individual.

10. The method of claim 1, comprising initiating an alarm in the event that the individual does not have all of the required equipment.

11. The method of claim 1, comprising associating a smart tag with the individual, the smart tag containing information identifying the individual.

12. The method of claim 1, wherein the smart tag information includes a link to a remote database having information regarding the equipment.

13. The method of claim 11, wherein the scanner accesses the remote database and displays information there from.

14. The method of claim 13, wherein the remote database is an Internet site, the scanner being an Internet accessible device.

15. The method of claim 1, wherein the equipment includes a protective device.

16. A system of providing feedback to personnel performing a given procedure, the system comprising:
at least one sensor carried by each piece of required equipment, the sensor configured to contain information to identify the piece of equipment it is configured with;
at least one sensor carried by an individual, the sensor configured to detect a hazard;
at least one sensor configured to detect at least one characteristic of an individual's physiological condition, the sensor positioned adjacent an individual during a procedure;
a scanner carried by an individual to permit communication with sensors, the scanner configured to send and receive signals from the sensors, the scanner configured to communicate information from the sensors to an individual when a change is detected, the scanner configured to communicate countermeasures available to an individual to counteract the change.

17. The system of claim 16, wherein the equipment includes a garment.

18. The system of claim 16, wherein the equipment includes a protective device.

19. The system of claim 16, wherein the sensor on the equipment includes a smart tag.

20. The system of claim 16, wherein the sensor carried by an individual includes a biosensor.

21. The system of claim 16, wherein one sensor configured to detect at least one characteristic of an individual's physiological condition includes a medical sensor.

22. The system of claim 21, wherein the medical sensor includes a transmitter associated therewith.

23. The system of claim 16, wherein a change includes a change in an environment, a failure in equipment, a loss of equipment detected by a sensor, a lack of all equipment required for a procedure detected by a scan, any negative alteration of a physiological characteristic of an individual being scanned, and any combination thereof.

24. The system of claim 16, wherein countermeaures includes any item carried by an individual which at least partially counteracts a change and any information provided to an individual about a nearby location to obtain an item to at least partially counteract a change.

25. The system of claim 16, comprising displaying the identification of the pieces of equipment identified by the scanner to the individual.

26. The system of claim 16, comprising initiating an alarm in the event that the individual does not have all of the required equipment.

27. The system of claim 16, comprising associating a smart tag with the individual, the smart tag containing information identifying the individual.

28. The system of claim 16, wherein the smart tag information includes a link to a remote database having information regarding the equipment.

29. The system of claim 28, wherein the scanner accesses the remote database and displays information therefrom.

30. The system of claim 29, wherein the remote database is an Internet site, the scanner being an Internet accessible device.
